(19) United States
(12) Patent Application Publication
(10) Pub. No.: US 2008/0152551 A1
(43) Pub. Date: Jun. 26, 2008

(54) SCREENLESS MOVING BED REACTOR

(76) Inventors: John J. Senetar, Naperville, IL (US); Michael J. Vetter, Schaumburg, IL (US)

Correspondence Address: HONEYWELL INTELLECTUAL PROPERTY INC;PATENT SERVICES, 101 COLUMBIA DRIVE, P O BOX 2245 MAIL STOP AB/2B, MORRISTOWN, NJ, 07962, US

(21) Appl. No.: 11/614,323

(22) Filed: Dec. 21, 2006

(51) Int. Cl. B01J 8/08; B01J 19/00

(52) U.S. Cl. 422/145; 422/211

(57) ABSTRACT

An apparatus is presented for contacting a bed of particulate material with a cross flowing fluid, and which maintains the bed of particulate material within a retention volume. The apparatus includes panels for covering fluid inlet and outlet apertures and for retaining solid particles within the contacting bed. The apparatus is designed to promote the flow of solid particles through the bed and to prevent solid particles from spilling through inlet and outlet apertures.

### FIELD OF THE INVENTION

This invention relates to the field of fluid particle contact and to an apparatus for contacting fluids and particles. More specifically, this invention relates to a moving bed of particles with a cross-flowing fluid.

### BACKGROUND OF THE INVENTION

A wide variety of processes use radial flow reactors to provide for contact between a fluid and a solid. The solid usually comprises a catalytic material on which the fluid reacts to form a product, or an adsorbent for selectively removing a component from the fluid. The processes cover a range of processes, including hydrocarbon conversion, gas treatment, and adsorption for separation.

Radial flow reactors are constructed such that the reactor has an annular structure and that there are annular distribution and collection devices. The devices for distribution and collection incorporate some type of screened surface. The screened surface is for holding catalyst or adsorbent beds in place and for aiding in the distribution of pressure over the surface of the reactor, or adsorber, and to facilitate radial flow through the reactor bed. The screen can be a mesh, either wire or other material, or a punched plate. For a moving bed, the screen or mesh provides a barrier to prevent the loss of solid catalyst particles while allowing fluid to flow through the bed. The screen requires that the holes for allowing fluid through are sufficiently small to prevent the solid from flowing across the screen. Solid catalyst particles are added at the top, and flow through the apparatus and removed at the bottom, while passing through a screened-in enclosure that permits the flow of fluid over the catalyst. The screen is preferably constructed of a non-reactive material, but in reality the screen often undergoes some reaction through corrosion, and over time problems arise from the corroded screen or mesh.

The screens or meshes used to hold the catalyst particles within a bed are sized to have apertures sufficiently small that the particles cannot pass through. A significant problem is the corrosion of meshes or screens used to hold catalyst beds in place, or for the distribution of reactants through a reactor bed. Reactions can take place that cause a buildup of material on the screens which in turn plugs holes in the screen. Corrosion can also plug apertures to a screen or mesh. This creates dead volumes where fluid does not flow, and there is poor or no fluid-solid contact, and subsequently a loss of efficiency as well as wasted catalyst. Corrosion can also create larger apertures where the catalyst particles can then flow out of the catalyst bed with the fluid and be lost to the process increasing costs. This produces unacceptable losses of catalyst, and increases costs because of the need to add additional makeup catalyst.

The design of reactors to overcome these limitations can save significantly on downtime for repairs and on the loss of catalyst, which is a significant portion of the cost of processing hydrocarbons.

### SUMMARY OF THE INVENTION

New reactor designs can accommodate existing reactors, such that during upgrades of equipment, the reactor internals can be replaced when a new reload of catalyst is provided. Reactors using a catalyst flowing through the reactor with a fluid contacting the catalyst comprises an outer cylindrical partition having apertures defined therein. The reactor further includes an inner cylindrical partition having apertures defined therein, where the inner and outer cylindrical partitions are arranged in a concentric manner and form a toroidal space that defines a particle retention volume where catalyst can flow through. The reactor further includes a plurality of toroidally shaped outer louvers having a leading edge affixed to the outer cylindrical partition. The outer louvers have a leading edge affixed at a position above the apertures in the outer cylindrical partition, and a trailing edge extending downward into the particle retention volume. The reactor further includes a plurality of toroidally shaped inner louvers, with each inner louver having a leading edge affixed to the inner cylindrical partition at a position above the apertures in the inner cylindrical partition. The inner louvers have a trailing edge that extends downward into the particle retention volume of the reactor.

Other objects, advantages and applications of the present invention will become apparent to those skilled in the art from the following detailed description and drawings.

### BRIEF DESCRIPTION OF THE DRAWINGS

FIG. 1 is a first embodiment of the invention;

FIG. 2 is an annular configuration of the first embodiment of the invention; and

FIG. 3 is a second annular configuration of the invention.

### DETAILED DESCRIPTION OF THE INVENTION

Recent investigations into radial flow reactors for olefin cracking have indicated corrosion in likely to be substantial, and that corrosion products and precipitated material such as coke from upstream of the reactor are generated. These materials present significant corrosion and fouling problems for the reactor.

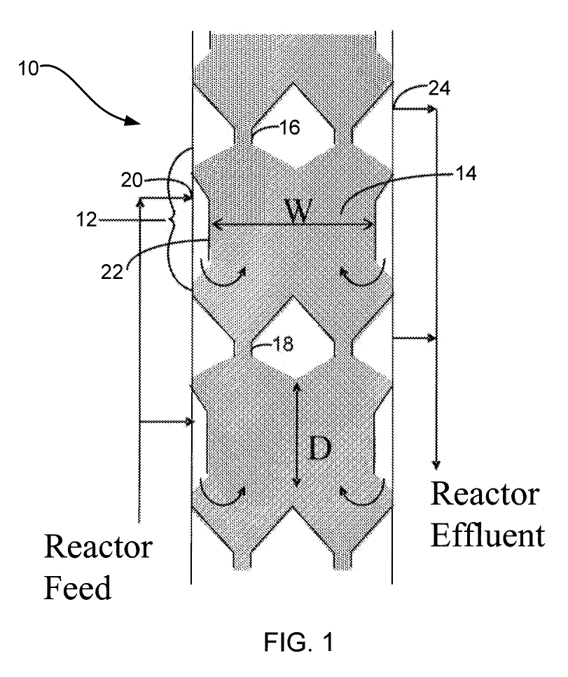

In one embodiment of the invention as shown in FIG. 1, the moving bed reactor 10 comprises a particle retention volume 14 where solid catalyst particles flow downward through the reactor 10. The phrase particle retention volume is used to describe the region where solid catalyst particles temporarily reside during the process, as the catalyst flows through the reactor, and is not meant to limit the term to a region where the catalyst resides without moving. The reactor 10 is made up of at least one reactor bed unit 12 where each reactor bed unit 12 has at least one solid particle inlet 16, and at least one solid particle outlet 18. The reactor 10 has a fluid inlet 20, that is covered by a panel 22 which prevents solid particles from the reactor 10 exiting through the fluid inlet apertures 20. The panel 22 extends into the particle retention volume at an angle between 10° and 60° degrees from vertical. The fluid flows into the reactor 10 and across the particle bed and exits a fluid outlet 24. The reactor bed unit 12 is shaped to direct the flowing solid particles to a solid particle outlet 18 of the unit 12. Typically, this will entail a slanted wall, or a conically shaped region, at the bottom of the reactor bed unit 12, and preferably the wall will have an angle greater than about 45 degrees from horizontal. This embodiment can comprise multiple units 12 stacked in a manner such that the particle outlet 18 from an upper unit 12 is the particle inlet 16 to a lower unit. The fluid inlet 20 can comprise apertures in fluid communication with the reactor feed, or can comprise channels underneath the panels 22 where the channels are in fluid communication with the reactor feed through a manifold or other means. The fluid flows up through the reactor bed 14 and out the fluid outlet 24. The depth of the contacting zone, D, should be greater than 0.5 times the width, W, of the contacting zone. This is to promote good distribution of the fluid through the solid particle bed for good contacting of the fluid with catalyst within the bed.

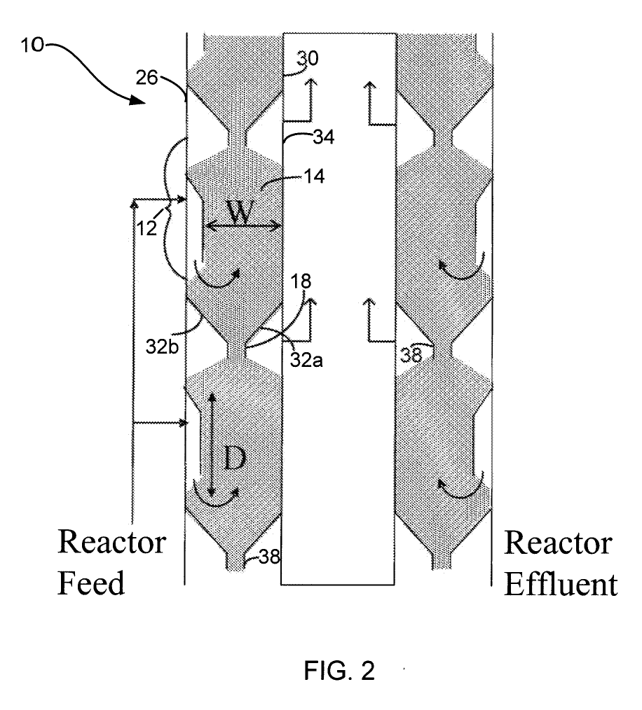

In a variation of this embodiment, the reactor 10 can have an annular configuration, as shown in FIG. 2. With an annular configuration, the reactor 10 comprises an external cylindrical partition 26 and an inner cylindrical partition, or centerpipe, 30. The space between the external cylindrical partition 26 and the centerpipe 30 defines the particle retention volume 14 for holding solid catalyst particles that flow through the reactor. The reactor 10 comprises a plurality of reactor bed units 12 which are annular sections that hold the solid catalyst particles in a reactor bed. In the annular configuration, the reactor unit outlet 18 comprises two annular louvers 32a, 32b. An inner annular louver 32a has a leading edge affixed to the centerpipe 30 at a position above a fluid outlet 34. The leading edge of the louver 32a is defined as the upstream edge relative to the flow of catalyst through the reactor 10. The louvers 32a, 32b extend into the particle retention volume at an angle between about 10° and about 60° from vertical, and the trailing edge of the louver 32a extends below the leading edge. In one variation, the louvers 32a, 32b further include vanes 38, where the vanes 38 have a leading edge affixed to the trailing edge of the louvers 32a, 32b and extend vertically downward from the louvers 32a, 32b.

The annular configuration for the reactor 10 provides a benefit of using the center pipe 30 as the outlet manifold for collecting the reactor effluent stream. In another variation with the annular configuration, the center pipe 30 can be used to direct the feed stream to the reactor inlet with the reactor effluent drawn off from around the external cylindrical partition.

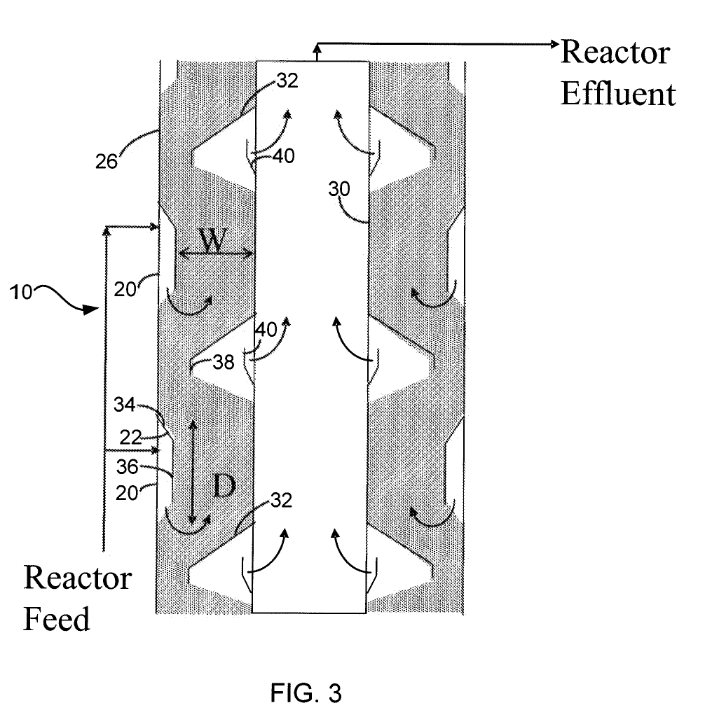

In a preferred embodiment, the reactor 10 of the present invention has an annular configuration as shown in FIG. 3. The reactor 10 comprises an external cylindrical partition 26 and an inner cylindrical partition, or centerpipe, 30, with the space between the partitions defining the particle retention volume, or reactor. The fluid inlets 20 are defined in the external cylindrical partition 26, and have an annular panel 22 that covers the inlets 20. The annular panel 22 is a structure that has an angled top portion 34 and a substantially vertical portion 36. The angled top portion 34 has an orientation of between 10° and 60° from vertical, and the vertical portion 36 extends to a position below the bottom of the inlet aperture 20. The panel 22 distributes the fluid entering the reactor 10 over the surface of the catalyst. The fluid outlets 24 are covered with a louver 32 that has a leading edge affixed to the centerpipe 30. In a preferred configuration, the louvers 32 extend into the particle retention volume about 50% of the spacing between the external cylindrical partition 26 and the inner cylindrical partition 30, and at an angle between 10° and 60° from vertical. This facilitates the mixing of the catalyst such that catalyst will not get stranded in dead zones. It is preferred that the depth, D, of the contacting zone be at least 0.5 times the width, W, of the contacting zone. The reactor 10, optionally, includes vanes 40 disposed under the louvers 32. The vanes 40 have an edge affixed to the inner cylindrical partition 30 at a position below the fluid outlets 24, and extend upwards away from the catalyst bed into the region underneath the louvers 32. The vanes 40 can be shaped and sized to control the flow of the fluid exiting the reactor, and can provide protection against catalyst rising under the louvers 32 during periods of start up or cooling down in the operation of the reactor 10.

The annular panel 22 can also be made of two pieces, a first piece 34 comprising having a leading edge affixed to external cylindrical partition 26 and a trailing edge extending downward into the particle retention volume at an angle between 10° and 60° from vertical. The panel 22 is further made up of a second piece 36 having a leading edge that is affixed to the trailing edge of the first piece 34, and extends substantially vertically downward from the first piece 34.

In an alternative embodiment, the reactor includes a first partition, where the first partition has apertures defined therein. The reactor further includes a second partition spaced from the first partition to define a particle retention volume, and where the second partition has apertures defined therein. The particle retention volume is a space where catalyst resides during the operation of the reactor. The catalyst can flow through the particle retention volume during operation with a fluid flowing over the catalyst. The apertures defined in the first partition include first louvers. The first louvers have a leading edge affixed to the first partition in a position above an aperture, and the louver has a trailing edge that extends into the particle retention volume at an angle between 10° and 60° from vertical. The trailing edge extends to a position at least as low as the lower edge of the aperture to which the louver is covering. The leading edge and trailing edge are referenced with respect to the flow of catalyst through the reactor, where the leading edge is the edge upstream of the trailing edge in the stream of catalyst. The apertures defined in the second partition include second louvers, where the second louvers have a leading edge affixed to the second partition above an aperture in the second partition. The second louvers have a trailing edge that extends into the particle retention volume at an angle between 10° and 60° from vertical and extends to a position at least as low as the lower edge of the aperture to which the louver is covering.

The operation of this reactor can be controlled through controlling the pressure at the inlets 20 and controlling the pressure drop across the system. Specific operations can also be controlled through variations in design, such as decisions regarding the number and locations of the inlets 20 and the outlets 24 of the reactor 10. In one operation regime, the fluid enters through the inlets 20 of the reactor 10, rises through the catalyst bed 14 and the reacted fluid exits through the outlets 24. In an alternate operation, the fluid can enter the reactor with the catalyst at the top of the reactor and flow down with the catalyst, separating from the solid catalyst particles and exiting through the reactor outlets 24.

While the invention has been described with what are presently considered the preferred embodiments, it is to be understood that the invention is not limited to the disclosed embodiments, but it is intended to cover various modifications of the plates, combinations of plates, and equivalent arrangements included within the scope of the appended claims.

What is claimed is:

1. A reactor comprising:
a first solid partition having apertures defined therein;
a second solid partition having apertures defined therein, wherein the first and second partitions define a particle retention volume, and where the inner wall of a partition is the side facing the particle retention volume;
a plurality of first louvers, each first louver having a leading edge affixed to the inner wall of the first partition and a trailing edge extending into the particle retention volume, wherein the first louvers cover the apertures of the first partition; and
a plurality of second louvers, each second louver having a leading edge affixed to the inner wall of the second partition and a trailing edge extending into the particle retention volume, wherein second louvers cover the apertures of the second partition.

2. The reactor of claim 1 wherein:
the first partition is an outer cylindrical surface;
the second partition is an inner cylindrical surface, with the particle retention volume defined between the outer and inner partitions, and the inner cylindrical partition forming an interior pipe;
the plurality of first louvers are toroidally shaped outer louvers, each outer louver having an outer edge affixed to the inner wall of the outer cylindrical partition and an inner edge extending into the particle retention volume, wherein the outer louvers cover the apertures of the outer cylindrical partition; and
the plurality of second louvers are toroidally shaped inner louvers, each inner louver having an inner edge affixed to the inner wall of the inner cylindrical partition and an outer edge extending into the particle retention volume, wherein inner louvers cover the apertures of the inner cylindrical partition.

3. The reactor of claim 1 wherein the fluid inlet comprises a conduit extending into the contacting zone, and wherein the openings in the conduit are oriented in a downward direction.

4. The reactor of claim 1 wherein the first louvers comprise two parts, a first part having the leading edge affixed to the inner wall and a trailing edge extending into the particle retention volume, and a second part having a first edge affixed to the trailing edge of the first part and extending substantially vertically downward.

5. The reactor of claim 1 wherein the second louvers comprise two parts, a first part having the leading edge affixed to the inner wall and a trailing edge extending into the particle retention volume, and a second part having a first edge affixed to the trailing edge of the first part and extending substantially vertically downward.

6. A cylindrical reactor comprising:
an outer cylindrical partition having apertures defined therein;
an inner cylindrical partition having apertures defined therein, wherein the outer and inner surfaces define a particle retention volume, and the inner cylindrical partition forming a pipe;
a plurality of toroidally shaped outer louvers, each outer louver having a leading edge affixed to the inner wall of the outer cylindrical partition and a trailing edge extending into the particle retention volume, wherein the outer louvers cover the apertures of the outer cylindrical partition; and
a plurality of toroidally shaped inner louvers, each inner louver having a leading edge affixed to the inner wall of the inner cylindrical partition and a trailing edge extending into the particle retention volume, wherein inner louvers cover the apertures of the inner cylindrical partition.

7. The reactor of claim 6 wherein the apertures of one of the cylindrical partitions are inlet apertures and covered by inlet louvers and the apertures of the other cylindrical partition are outlet apertures and covered by outlet louvers, further comprising a plurality of diversion vanes, wherein each vane is affixed to the cylindrical partition with the outlet apertures and below the louvers covering the outlet apertures.

8. The reactor of claim 7 wherein the outlet louvers extend into the particle retention volume at least 50% of the distance between the inner partition and the outer partition.

9. The reactor of claim 6 wherein the particulate retention volume has a depth to width ratio of at least 0.5.

10. The reactor of claim 6 wherein the louvers further comprise a vertically oriented extension having an upper edge affixed to the trailing edge of the louver and extending downward for directional control of the particulate solids.

11. The reactor of claim 6 further comprising fluid vanes disposed beneath the inner louvers, and having a lower edge affixed to the inner cylindrical surface at a position below the aperture covered by the inner louver.

12. A reactor where a solid particulate material flows downward and a fluid flows through the reactor comprising:
a reactor unit comprising:
a contacting zone for holding a solid particulate matter, wherein the contacting zone comprises:
solid side partitions for containing the solid particulate matter;
a solid particle inlet;
a solid particle outlet;
a fluid inlet, wherein the fluid inlet is covered with a panel to prevent solid particles entering the contacting zone to exit the fluid inlet; and
a fluid outlet.

13. The reactor of claim 12 wherein the contacting zone has a depth to width ratio of at least 0.5.

14. The reactor of claim 12 wherein the solid side partitions form a toroidal structure to create a cylindrical reactor.

15. The reactor of claim 12 wherein the solid particle inlet comprises louvers that cover the fluid outlet to prevent the egress of solid particles through the fluid outlet.

16. The reactor of claim 12 wherein the solid particle outlet comprises at least one louver having a leading edge affixed to the solid side partition at a position above the fluid inlet, and a trailing edge extending into the contacting zone at an angle from 10 deg. to 60 deg from vertical.

17. The reactor of claim 16 wherein the louver further comprises a vane having a first edge affixed to the trailing edge of the louver and extending substantially vertically downward.

18. The reactor of claim 12 comprising a plurality of reactor units stacked in a manner such that the solid particle outlet of an upper reactor unit is the solid particle inlet of the reactor unit directly beneath the upper reactor unit.

19. The reactor of claim 12 further comprising:
an inlet manifold in fluid communication with the fluid inlet, for carrying a reactor feed stream; and
an outlet manifold in fluid communication with the fluid outlet, for carrying a reactor effluent stream.
